(19) United States
(12) Patent Application Publication
(10) Pub. No.: US 2006/0208489 A1
(43) Pub. Date: Sep. 21, 2006

(54) Watertight joint

(76) Inventor: Neil Edwin Wallace, (US)

Correspondence Address: HAHN LOESER & PARKS, LLP, One GOJO Plaza, Suite 300, AKRON, OH, 44311-1076, US

(21) Appl. No.: 10/564,411

(22) PCT Filed: Jul. 9, 2004
(86) PCT No.: PCT/AU04/00933

§ 371 Date: Jan. 11, 2006

(30) Foreign Application Priority Data
Jul. 11, 2003 (AU) 2003903578

(51) Int. Cl. F16L 25/00

(52) U.S. Cl. 285/424

(57) ABSTRACT

A article (10) formed at least partially from at least one metal sheet incorporates at least one lockseam (20) that interconnects adjacent edge margins (18 and 19) of the sheet 17. The lockseam (20) includes a region where the edges overlap and wherein at least one of the edge margins has a coating (23) applied to it that is disposed in the overlap and forms a gasket to provide a watertight at the lockseam. A method of forming the lockseam is also disclosed.

### TECHNICAL FIELD

The present invention relates generally jointing techniques for metal sheet and more specifically to such joints that are watertight. The invention has particular application to articles that contain or carry water (or other fluids) and the invention is herein described in that context.

### BACKGROUND

There are many instances where metal articles are used in containing or carrying water. Common examples include metal water tanks and piping systems. Water tanks need to resist hydrostatic pressure as a result of water pressure head whereas the piping system include pressure pipes that are typically rated to withstand pressures in the vicinity of 4 bar and stormwater pipes and the like which are not pressure rated and are designed to carry water under lower pressure.

These articles are in some instances made from sheet metal, and in their manufacture, it is common to join edge margins of the sheet material (or of adjacent sheets) so as to form a watertight joint at those margins. In the past, these joints have been formed either by welding or by forming a seam by overlapping the edge margins with the seam being made watertight through the use of a gasket located in the seam, and/or by the application of a sealing compound such as a silicone to the seam. Whilst these techniques have been effective there is a continuing need to develop new techniques that facilitate the manufacturing process of the articles.

### SUMMARY OF INVENTION

In a first aspect, the invention relates to an article at least partially formed from at least one metal sheet and incorporating at least one lockseam that interconnects adjacent edge margins of the at least one sheet, the lockseam including a region where the edges overlap and wherein at least one of the edge margins has a coating applied to it that is disposed in the overlap and forms a gasket to provide a watertight joint at the lockseam.

An advantage of the present invention is that it facilitates manufacture of the article, as the coating is pre-applied to the sheet thereby allowing the watertight joint to be formed merely on the formation of the lockseam.

In one form, both edges in the overlap incorporate the coating and wherein the coating of one edge is in engagement with the coating of the other edge in the overlap to form the watertight joint.

In one form, the lockseam is caused to compress the coating in the overlap. In one form, the coating is compressed by an amount in the range of 10-50% of its original thickness.

In one form, the coating is in the form of a polymeric film. In a particular form, the polymeric film is applied across at least one of the major surfaces of that sheet so as to provide a moisture barrier and/or to enhance the chemical resistance of the sheet. A particular advantage of this arrangement is that by utilising the same polymeric film that is applied to the sheet as a moisture barrier or to enhance chemical resistance of the article, it allows the formation of a watertight joint solely by forming the lockseam without requiring any additional step in the process.

Polymeric films that may be used include low density or high density polyethylene, PVC, and polypropylene.

The thickness of the film is preferably in the range of 100 to 400 microns.

In one form, the thickness of the metal sheet is between 0.35-3.00 mm. In one form, the metal sheet is steel that incorporates a corrosion resistant metal coating.

In another form, the coating is applied only along the edge margin. Examples of suitable edge coatings include the polymeric films described above and natural rubber or synthetic rubbers such as neoprene.

In one form, one edge margin is folded over the other edge margin so that the one edge margin abuts both sides of the other edge margin.

The construction of the lockseam and in particular the length of overlap incorporated in the seam will depend to some extent on the required pressure that the article needs to withstand. Moreover, the effectiveness of the seal may in fact improve when pressure increases in the article as the edge margins of the lockseam are preferably designed to move into tighter engagement on an increase in pressure in the article.

In one form, the edge margins in the overlap are generally flat. In an alternative form, a camber is introduced in the overlap to increase the ability of the lockseam to resist tensile force induced at the lockseam.

In a further aspect, the invention relates to a method of forming a watertight joint between two edge margins formed of metal sheet, the method comprising the steps of:

providing at least one of the two edge margins with a coating applied to it; and

interconnecting the edge margins to form a lockseam, the edge regions being arranged to overlap in the lockseam with the coating being located in the overlap between the metal sheets.

In one form, the method further comprises the step of applying pressure to the edge margins so as to compress the coating in the lockseam so as to make the joint watertight.

In one form, the method further comprises the steps of:

providing both of the two edge margins with a coating; and

connecting the edge margins to form the lockseam with the coating of one edge being in engagement with the coating of the other edge in the overlap.

In one form, the method further comprises the step of forming the lockseam by folding over one edge margin over the other edge margin so that the one edge margin abuts both sides of the other edge margin.

In one form, a clinching force is applied to the edge margins so as to compress the coating in the lockseam. In one form, this clinching force is applied to the lockseam via a roll forming operation.

In one form, the method further comprises applying a film to the metal sheet so as to form the coating on the at least one of the two edge margins. In one form, the film is applied to substantially all of at least one of the major surfaces of the metal sheet so as to provide a moisture barrier and/or to enhance the chemical resistance of the sheet.

In one form, pressure is applied to the edge margins so as to compress the coating in the lockseam by an amount in the range of 10-50% of its original thickness. In this way, the resulting thickness of the compressed coating is in the range of 50 to 90% of its original thickness.

### BRIEF DESCRIPTION OF THE DRAWINGS

It is convenient to hereinafter describe embodiments of the present invention with reference to the accompanying drawings. The particularity of the drawings and the related description is to be understood as not superseding the generality of the preceding broad description of the invention.

In the drawings:

FIG. 1 is a schematic perspective view of a water tank having a tank wall incorporating a lockseam;

FIG. 2 is a plan view of the tank of FIG. 1;

FIG. 3 is a detailed cross-sectional view of the lockseam in the tank wall of FIG. 1;

FIGS. 4a to 4d are schematic views illustrating the formation of the lockseam of FIG. 3; and

FIG. 5 illustrates the formation of a variation of the lockseam of FIG. 3.

### DETAILED DESCRIPTION OF THE DRAWINGS

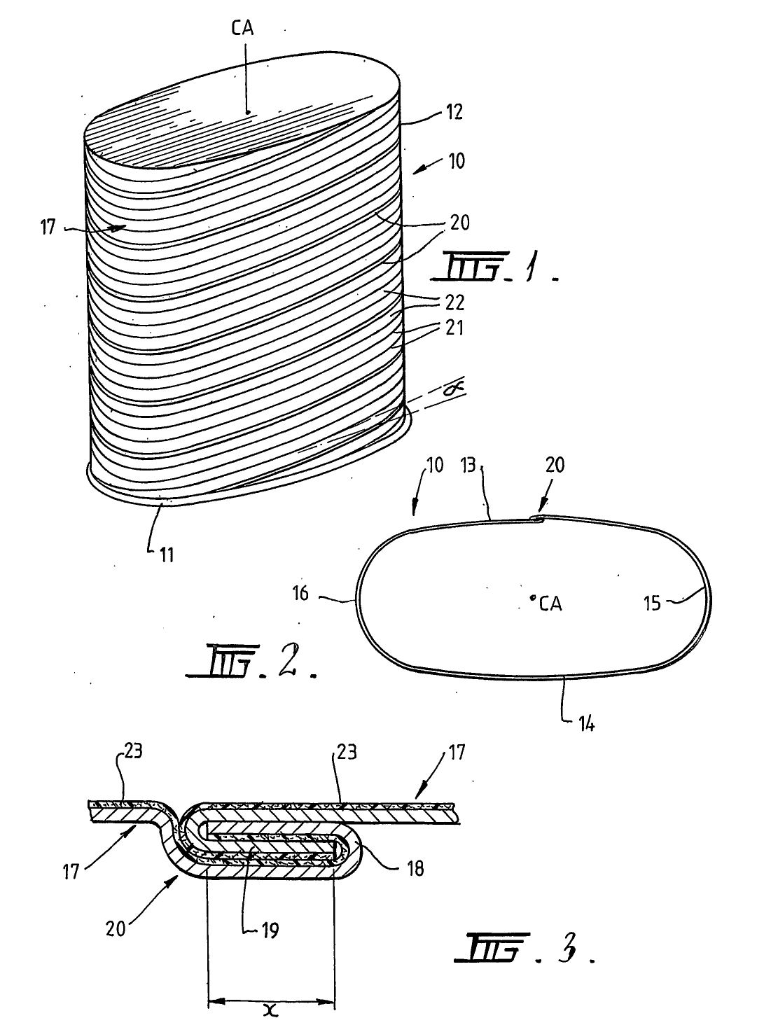

Turning firstly to FIGS. 1 and 2, a water containing article in the form of a rain water storage tank 10 is disclosed which is generally obround in cross section. The tank includes a base 11 and tank wall 12 which extends upwardly from the base. The tank wall 12 includes opposite generally parallel sides 13 and 14 and generally semi-circular ends 15 and 16.

The tank 10 is made from sheet metal, with the tank wall 12 being formed by a single length of metal sheet 17, which is helically wound around a central axis (CA) of the tank. To ensure that the tank wall 12 is continuous, a lockseam 20 is provided which interconnect the opposing longitudinal edges 18, 19 (see FIG. 3) of the sheet metal strip 17 that locate adjacent one another when the strip 17 is wound in a helix. The lockseam 20 similarly extends helically about the tank axis CA. The sheet 17 is helically wound so that the pitch angle α as illustrated in FIG. 1, is relatively low and is typically in the range of 0.1 to 5°. Further, in the illustrated form, the ribs 21 project outwardly from the tank. However it is to be appreciated that the tank may be wound so that the ribs extend inwardly. This latter option has the advantage as it provides a smoother exterior surface with the outer surface of the pans 22 forming the outer margins of the tank wall 12.

The water tank 10 is the subject of a copending International application by the Applicant entitled “Improved Water Tank and Method of Making Same”, the contents of which are herein incorporated by cross reference.

The sheet metal strip 17 is formed from a high tension or mild steel which typically has thickness of 0.35-3.0 mm and incorporates a protective coating which is formed from zinc or a zinc mixture. The sheet steel is also laminated with a protective polymer based film 23 which provides superior chemical resistance and enhanced moisture barrier. One such LD polyethylene film is sold under the trade mark TRENCHCOAT LG® which is a trade mark of the Dow Chemical Company. Another suitable PVC coated steel sheet is sold by the Applicant under the trade mark AQUAPLATE®. The thickness of the coating is preferably in the range of 100 to 400 microns.

FIG. 3 illustrates the lockseam 20 provided in the tank wall and which joins the longitudinal edges 18 and 19 of the metal strip. The lockseam 20 is formed by folding over lapping portions 18 and 19. The lockseam is designed so that outward hydrostatic pressure forces the seam into tighter engagement thereby improving the seal between the longitudinal edges 18 and 19. In this arrangement, the lockseam is arranged so that the edges overlap with the film 23 of one edge in facing relation with the film 23 of the other edge. Further, the lapping edges are forced together under pressure to thereby compress the coating 40. In the illustrated form, the overlap formed in the lockseam may vary depending on the design requirement of the seam 20. In the general terms, increasing the overlap increases the strength of the lockseam and increases the sealing surface providing the watertight joint. The Applicant has found that an overlap of 3-10 mm is suitable for water tank applications.

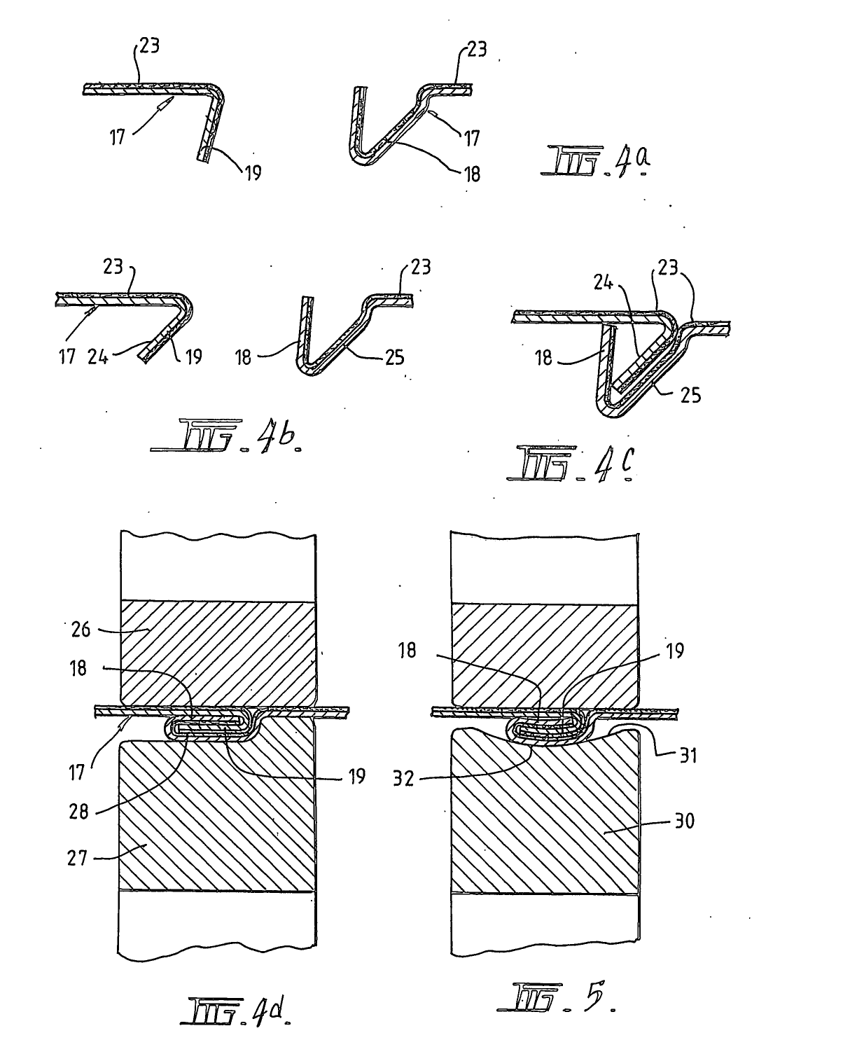

FIGS. 4a to 4d illustrate schematically the steps in manufacture of the lockseam.

In a first stage as illustrated in FIG. 4a, the edge margins 18, 19 of the metal strip 17 are initially roll formed to form one edge margin 18 as a channel and the other edge margin 19 as a flange. In a second stage, as illustrated in 4b, the angle of the flange edge margin 19 is made more acute so that a distal end 24 is inclined at an angle that is substantially consistent to a proximal portion 25 of the channel edge margin 18.

In a third stage, as illustrated in FIG. 4c, the flange edge margin 19 is inserted into the channel edge margin 18 with the distal portion 24 of the flange margin locating adjacent the proximal portion 25 of the channel edge margin 18. In an alternative arrangement (not shown), the second stage of the process as illustrated in 4b is omitted so that when the flange is inserted into the channel as illustrated in FIG. 4c, the distal portion 24 of the flange edge margin 19 is mutually inclined to the proximal portion 25 of the channel edge margin 18.

In a fourth stage, as illustrated in FIG. 4d, inner and outer clinching rollers (26 and 27 respectively) are applied to opposite sides of the overlapping edge margins 18 and 19. In the illustrated form, the inner clinching roller 26 is a flat roll whereas the outer roller 27 is a shaped roll that determines the external profile of the lockseam 20. In undergoing clinching of the edge margin, the coating located within the overlap is compressed by an amount in a range of 10 to 50% of its original coating thickness. This compression of the coating provides a sealing surface, particularly in the region 28 where the coating 23 of the edge regions 18 and 19 overlap.

FIG. 5 illustrates an alternative form of outer clinching roller 30. In the embodiment of FIG. 5, the outer clinching roller incorporates an arcuate engaging surface 31 which is caused on clinching of the lockseam 20 to introduce a camber 33 in the lockseam 20. The purpose of the camber is to increase the strength of the lockseam particularly under tensile force. An increase in the lockseam's strength under tension is beneficial as it increases the capacity of the lockseam to resist hydrostatic forces. Also, if the metal sheet 17 is worked, such as by the introduction of a corrugated profile into the metal sheet 17 after formation of the lockseam 20 (as disclosed in the Applicant's corresponding International application relating to the water tank mentioned above), such working of the metal induces significant tensile force in the lockseam. Accordingly, the introduction of a camber improves the capacity of the lockseam to cope with such tensile forces.

To further illustrate the operation of the lockseam 10, the following examples are provided.

### EXAMPLES

Test 1 Cyclic Testing

A spirally wound barrel was produced with a ¼ inch Triple Rib Profile using a 0.71 mm galvanised steel base with a single sided coating of 300 micron TRENCHCOAT® coating. A helical lockseam of the type of FIG. 3 was produced in forming the barrel. The lockseam had an overlap of 3 mm and the coating in the overlap was compressed by 25%. Barrel dimension was 760 mm diameter and 1.5 m high representing a holding volume of 680 litres.

A concrete base was subsequently formed around the barrel and the concrete cured to form a tank. The base and the join with the barrel were then coated with a sealant to prevent water seepage through the concrete or join.

The tank was then filled to the top and a visual check conducted for leaks. No leaks were detected through either the lockseams or through the join to the concrete base.

Using a sump pump, the tank was then drained into a holding vessel and the pump reversed to refill the test tank. A visual check was again conducted for leaks. This cycle was repeated 15 times over a period of one week and no leaks were detected at any stage.

Test 2 Pressure Testing

Ten spirally wound barrels were produced with a 2⅔″×½″ corrugated profile using a 0.6 mm galvanised steel base with a single sided coating of 200 micron AQUAPLATE® coating. A helical lockseam of the type of FIG. 3 was produced in forming each of the barrels. The lockseams had an overlap of 3 mm and the coating in the overlap was compressed by 25%. Barrel dimension was 1800 mm diameter and 2.5 m high representing a holding volume of 6360 litres.

A double sided AQUAPLATE coated 0.6 mm steel disc was formed around the base of the barrels by folding over a flanged end and sealing with a silicon sealant.

All 10 tanks were filled to the top representing a 2.5 metre “head” of water.

A visual inspection was conducted for leaks. In two instances leaks were detected in lockseams where the lockseam had been damaged through handling. Where no damage had been incurred no leaks were detected.

Accordingly, a lockseam is provided which forms a waterjoint between the edge margins of metal sheet. The watertight joint is formed by incorporating a polymer coating within the overlap of the lockseam which is compressed and acts as a gasket to provide a sealing effect in the joint. Further, tests conducted by the Applicant indicated that the lockseam is capable of withstanding hydrostatic pressure and also to withstand variations in pressure under cycle testing. Whilst in both the above examples, the tests were conducted with the lockseam incorporated in a water tank, the tests also indicate the suitability of the lockseam in other applications, in particular piping systems where the lockseams could easily be incorporated in a spiral wound metal pipe.

In the claims which follow and in the preceding description of the invention, except where the context requires otherwise due to express language or necessary implication, the word “comprising” is used in an inclusive sense, i.e. the features specified may be associated with further features in various embodiments of the invention.

It will be appreciated that variations and/or modifications may be made to the parts previously described without departing from the spirit or ambit of the invention.

1-26. (canceled)

27. An article formed at least partially from at least one metal sheet and incorporating at least one lockseam that interconnects adjacent edge margins of the at least one sheet, the lockseam including a region where the edge margins overlap and wherein at least one of the edge margins has a coating applied to it that is disposed in the overlap and forms a gasket to provide a watertight joint at the lockseam.

28. An article according to claim 27, wherein the coating is compressed in the overlap.

29. An article according to claim 28, wherein the coating is compressed by an amount in the range of 10-50% of its original thickness.

30. An article according to claim 27, wherein the coating is in the form a polymeric film.

31. An article according to claim 30, wherein the polymeric film is applied across at least one of the major surfaces of the at least one sheet so as to provide a moisture barrier and/or to enhance the chemical resistance of the sheet.

32. An article according to claim 31, wherein the polymeric film is selected from the group consisting of: low density or high density polyethylene, PVC, and polypropylene.

33. An article according to claim 32, wherein the thickness of the film is in the range of 100 to 400 microns.

34. An article according to claim 27, wherein the coating is applied only along the at least one edge margin.

35. An article according to claim 34, wherein the coating is selected from the group consisting of low density or high density polyethylene, PVC, polypropylene, natural or synthetic rubber.

36. An article according to claim 27, wherein the thickness of the metal sheet is between 0.35-3.00 mm.

37. An article according to claim 36, wherein the metal sheet is steel that incorporates a corrosion resistant metal coating.

38. An article according to claim 27, wherein one edge margin is disposed around an end portion of the other edge margin so that the one edge margin has a first portion that abuts one side of the end portion, and a second portion that abuts the other side of that end portion.

39. An article according to claim 38, wherein the first and second portions of the one end margin and the end portion of the other edge margin are generally flat.

40. An article according to claim 38, wherein the first and second portions of the one edge margin and the end portion of the other edge margins are cambered.

41. An article according to claim 27, wherein the article is a metal pipe.

42. An article according to claim 41, wherein the article is a metal spiral wound pipe.

43. An article according to claim 27, wherein the article is a metal tank.

44. An article formed at least partially from at least one metal sheet and incorporating at least one lockseam that interconnects adjacent edge margins of the at least one sheet, the lockseam including a region where the edge margins overlap and wherein both edge margins have a coating applied thereto, wherein the coating of one edge margin is in engagement with the coating of the other edge margin to form a gasket between the edge margins.

45. An article according to claim 44, wherein the coatings are compressed in the overlap.

46. An article according to claim 45, wherein the coatings are compressed by an amount in the range of 10-50% to their original thickness.

47. An article according to claim 44, wherein the coatings are in the form polymeric films.

48. An article according to claim 47, wherein a polymeric film forms the coating on the edge margins and is applied across one of the major surfaces of the at least one sheet so as to provide a moisture barrier and/or to enhance the chemical resistance of the sheet.

49. An article according to claim 48, wherein the polymeric film is selected from the group consisting of: low density or high density polyethylene, PVC, and polypropylene.

50. An article according to claim 49, wherein the thickness of the film in the range of 100 to 400 microns.

51. An article according to claim 44, wherein the coatings are applied only along the edge margins.

52. An article according to claim 51, wherein the coatings are selected from the group consisting of low density or high density polyethylene, PVC, polypropylene, natural or synthetic rubber.

53. An article according to claim 44, wherein the thickness of the metal sheet is between 0.35-3.00 mm.

54. An article according to claim 53, wherein the metal sheet is steel that incorporates a corrosion resistant metal coating.

55. An article according to claim 44, wherein one edge margin is disposed around amend portion of the other edge margin so that the one edge margin has a first portion that abuts one side of the end portion, and a second portion that abuts the other side of that end portion.

56. An article according to claim 55, wherein the first and second portions of the one end margin and the end portion of the other edge margin are generally flat.

57. An article according to claim 55, wherein the first and second portions of the one edge margin and the end portion of the other edge margins are cambered.

58. An article according to claim 44, wherein the article is a metal pipe.

59. An article according to claim 58, wherein the article is a metal spiral wound pipe.

60. An article according to claim 44, wherein the article is a metal tank.

61. A method of forming a watertight joint between two edge margins formed of metal sheet, the method comprising the steps of:
providing at least one of the two edge margins with a coating applied to it; and
interconnecting the edge margins to form a lockseam, the edge regions being arranged to overlap in the lockseam with the coating being located in the overlap between the metal sheets.

62. A method according to claim 61, further comprising the step of:
applying pressure to the edge margins so as to compress the coating in the lockseam.

63. A method according to claim 62, wherein a clinching force is applied to the edge margins so as to compress the coating in the lockseam.

64. A method according to claim 62, wherein pressure is applied to the edge margins so as to compress the coating in the lockseam by an amount in the range of 10-50% of its original thickness.

65. A method according to claim 61, further comprising the steps of:
providing both of the two edge margins with a coating; and
connecting the edge margins to form the lockseam with the coating of one edge margin being in engagement with the coating of the other edge margin in the overlap.

66. A method according to claim 65, further comprising the step of:
applying pressure to the edge margins so as to compress the coatings in the lockseam.

67. A method according to claim 61, further comprising the step of forming the lockseam by folding over one edge margin around the other edge margin so that the one edge margin abuts both sides of the other edge margin.

68. A method according to claim 61, further comprising the step of applying a film to the at least one metal sheet so as to form the coating on the at least one of the two edge margins.

69. A method according to claim 68, wherein the film is applied to substantially all of at least one of the major surfaces of the metal sheet so as to provide a moisture barrier and/or to enhance the chemical resistance of the sheet.

70. A watertight joint formed between first and second metal sheet margins, the edge margins interlocking in overlapping relation to form a lockseam, wherein at least one of the edge margins incorporates a coating that forms a gasket between the edge margins.

71. A watertight joint formed between first and second metal sheet edge margins, the edge margins interlocking in overlapping relation to form a lockseam, wherein each edge margin incorporates a coating and wherein the coating of one edge margin is in engagement with the coating of the other edge margin to form a gasket between the edge margins.
